(19) United States
(12) Patent Application Publication
(10) Pub. No.: US 2015/0235718 A1
(43) Pub. Date: Aug. 20, 2015

(54) REACTOR PRESSURE-RELIEVING FILTER SYSTEM

(71) Applicant: Westinghouse Electric Germany GmbH, Mannheim (DE)

(72) Inventors: Daniel FREIS, Linkenheim-Hochstetten (DE); Ralf Obenland, Mannheim-Niederfeld (DE); Wolfgang Tietsch, Mannheim (DE); Hans Martinsteg, Roetgen-Rott (DE)

(73) Assignee: Westinghouse Electric Germany GmbH, Mannheim (DE)

(21) Appl. No.: 14/487,508

(22) Filed: Sep. 16, 2014

Related U.S. Application Data
(63) Continuation of application No. PCT/EP2013/000733, filed on Mar. 13, 2013.

(30) Foreign Application Priority Data
Mar. 16, 2012 (DE) 102012005204.9

(51) Int. Cl. G21C 9/004; B01D 53/68; G21C 13/02; B01D 46/00

(52) U.S. Cl. CPC G21C 9/004; B01D 46/0084; B01D 46/0002; B01D 53/685; G21C 13/02; B01D 2253/116; B01D 2257/2068; B01D 2257/202

(57) ABSTRACT

The present disclosure relates to a reactor pressure-relieving filter system having an interior space hermetically enclosed by a pressure-resistant reactor casing, at least one pressure-relieving opening through the reactor casing, and a dry filter for a gas mass flow emerging from the pressure-relieving opening when there is excess pressure in the interior space. The filtering efficiency can depend both on the average dwell time of the gas mass flow in the dry filter and on the temperature difference between the gas mass flow and the respective dew point. A flow channel connects the pressure-relieving opening and the dry filter. A passive orifice plate is provided upstream of the dry filter in the flow channel.

### RELATED APPLICATION(S)

This application claims priority as a continuation application under 35 U.S.C. §120 to PCT/EP2013/000733, which was filed as an International Application on Mar. 13, 2013, designating the U.S., and which claims priority to German Application 10 2012 005 204.9 filed in Germany on Mar. 16, 2012. The entire contents of these applications are hereby incorporated by reference in their entireties.

### FIELD

The present disclosure relates to a reactor pressure-relieving filter system, such as a system having an interior space hermetically enclosed by a pressure-resistant reactor casing, at least one pressure-relieving opening through the reactor casing, a dry filter for a gas mass flow emerging from the pressure-relieving opening when there is excess pressure in the interior space, the filtering efficiency depending both on the average dwell time of the gas mass flow in the dry filter and on the temperature difference between the gas mass flow and the respective dew point, and a flow channel for connecting the pressure-relieving opening and the dry filter. The disclosure also relates to a corresponding method for dimensioning an orifice plate and a dry filter.

### BACKGROUND INFORMATION

It is known that nuclear power plants can have at least a gastight steel shell (confinement), but also a pressure-resistant and gastight reactor containment vessel (containment), that is to say a reactor casing that encloses the primary circuit with the reactor pressure vessel. The reactor casing, or the reactor containment vessel (RCV) or containment, act as a barrier for radioactive materials in the form of aerosols and gases, and can reliably prevent them from escaping into the surrounding environment during operation and during a design-based accident.

In an accident based on more than the design of the plant, for example in the event of a long-term failure of all the systems for afterheat removal, there may be an inadmissible pressure increase in the RCV even to the extent of failure. In order to prevent such a failure, and consequently the release of large amounts of radioactivity, in some nuclear power plants there are systems for controlled and filtered pressure relief.

A known method for filtered pressure relief is that known as the dry filter method. In the case of this method, the gas mass flow from the RCV is first conducted through a metal fibre filter, also known as an aerosol filter, for the separation of fission products in aerosol form and subsequently through what is known as a molecular sieve for the separation of iodine in gas form (elementary and organic), before it is released into the environment surrounding the power plant. Filtering has the effect of retaining a large part of the fission products. This makes it possible to avoid to the greatest extent short-term and long-term evacuation of the population and losses of land due to contamination.

As is known, the molecular sieve has a number of filter beds with a packing of silver-doped spherical zeolites. The zeolites have a high internal microporosity, and therefore have a very large specific surface area. The filter effect is based on the reaction between the silver applied over the entire effective zeolite surface and the gaseous iodine present in the gas mass flow. This process is known as chemical sorption.

The filtering efficiency of the molecular sieve depends substantially on the dwell time of the gas to be filtered in the filter bed and the available zeolite surface covered with silver atoms. This effective silver surface is for the most part within the zeolite pores. If there is an increase in the moisture content of the gas, these micropores are partly filled with water, so that as a result less surface, and consequently less silver, is available for the iodine transported in the gas to react. The efficiency of the filter therefore decreases with increasing moisture, or a lower temperature difference from the dew point.

After initiating pressure relief from a reactor casing, the internal pressure in the space enclosed by it and the initial gas mass flow are reduced in the course of the pressure relief. The dwell time of the gas mass flow in the molecular sieve or dry filter can therefore be particularly low at the beginning of a pressure relief, so that the dry filter is of a correspondingly large design, and consequently significantly overdimensioned for the lower mass flow towards the end of the pressure relief.

For better utilization of the dry filter, it is also provided that the gas mass flow is actively controlled by actions performed by personnel. For example, against the background of a conceivable scenario of a complete power failure and unavailability of personnel, this can lead to a situation in which the system cannot be used, or cannot be optimally used, in a case in which it is desired or required.

### SUMMARY

A reactor pressure-relieving filter system is disclosed, comprising: an interior space hermetically enclosed by a pressure-resistant reactor casing; at least one pressure-relieving opening through the reactor casing; a dry filter for a gas mass flow emerging from the pressure-relieving opening when there is excess pressure in the interior space, a filtering efficiency depending both on an average dwell time of the gas mass flow in the dry filter and on a temperature difference between the gas mass flow and a respective dew point; a flow channel for connecting the pressure-relieving opening and the dry filter; and a passive orifice plate provided upstream of the dry filter in the flow channel.

### BRIEF DESCRIPTION OF THE DRAWINGS

Other features, embodiments and advantages will be described in more detail on the basis of the exemplary embodiments that are represented in the drawings, in which:

FIG. 1 shows an exemplary reactor pressure-relieving filter system;

FIG. 2 shows an exemplary flow channel with an orifice plate; and

FIG. 3 shows an exemplary schematic profile of a dwell time, dew point difference and filtering efficiency during an exemplary pressure-relieving operation.

### DETAILED DESCRIPTION

A reactor pressure-relieving filter system is disclosed which can ensure a specific pressure relief and, for example, a high filtering efficiency during an entire pressure-relieving operation without any human intervention and without energy or media being externally supplied.

In an exemplary reactor pressure-relieving filter system, a passive orifice plate is provided upstream of the dry filter in the flow channel.

The method is based for example on use of a passive orifice plate for reducing the pressure of the gas mass flow before the dry filter. The orifice plate can in this case be designed in such a way that, when the pressure relief is initiated in the presence of a defined pressure in the interior space of the reactor casing, a desired pressure-relieving mass flow occurs. In exemplary embodiments, a majority of the pressure losses in the system thereby occur over the orifice plate, so that the static pressure before the dry filter is almost atmospheric. On account of the great pressure difference between the interior space of the reactor casing and the surrounding atmosphere into which the filtered gas mass flow is released during the pressure relief, critical flow states can thereby occur within the orifice plate. This pressure-reducing operation can have the effect of achieving an overheating of the gas mass flow, or for example of the vapour/gas mixture.

On account of the critical flow states in the orifice plate, the gas mass flow during pressure relief can be virtually proportional to the pressure in the interior space of the reactor casing. At the beginning of the pressure relief, when there is high internal pressure, the mass flow is relatively high (e.g., with respect to the end of the pressure relief); towards the end of the pressure relief, when there is low internal pressure, the mass flow is relatively low.

On the other hand, the difference from the dew point which can be achieved at the beginning of the pressure relief is relatively large on account of the overheating of the gas mass flow, and relatively small towards the end of the pressure relief.

With respect to the filtering efficiency of the dry filter, the two effects are contrary; that is to say, they can advantageously act counter to one another and, for example, ideally cancel one another out. Consequently, on the one hand a particularly short dwell time in the dry filter can therefore be obtained at the beginning of the pressure relief as a result of the high gas mass flow, but on the other hand the filter can have a particularly high efficiency on account of the high temperature of the gas mass flow and on account of the great difference there is then from the dew point.

This can, for example, provide a reactor pressure-relieving filter system that ensures a specific pressure relief and a high filtering efficiency during the entire pressure-relieving operation without any human intervention and without energy or media being externally supplied.

According to an exemplary configuration of the reactor pressure-relieving filter system as disclosed herein, the passive orifice plate is provided directly upstream of the dry filter. According to an exemplary embodiment, the distance between the orifice plate, where heating of the gas mass flow of course takes place due to pressure reduction, and the dry filter should be kept small, in order as far as possible to avoid cooling down the heated gas mass flow before it enters the dry filter. A flow distance in an exemplary range of several metres, or indeed even more than that, can for example be regarded as suitable for this. The filtering efficiency can thereby be increased in an advantageous way.

According to an exemplary embodiment of the reactor pressure-relieving filter system, in the entry region of the flow channel there is provided a rupture disc, which hermetically seals the latter and is configured in such a way that it ruptures when a certain rupturing pressure is exceeded.

Unlike known configurations, the pressure relief in an exemplary reactor pressure-relieving filter system as disclosed herein can be consequently initiated completely passively, by rupturing of the rupture disc when there is a defined pressure in the interior space of the core shroud. Active components can be consequently advantageously avoided.

According to an exemplary variant of the reactor pressure-relieving filter system, the region of the flow channel between the orifice plate and the dry filter can be thermally insulated, at least in certain portions, at its wall. Also in this way, cooling down of the heated gas mass flow can be reduced and the filtering efficiency can be advantageously increased. This variant is also appropriate for example, if for structural reasons the orifice plate and the dry filter cannot be in direct proximity, and a distance of for example several tens of metres has to be bridged.

According to an exemplary variant embodiment, upstream of the orifice plate in the flow channel there is provided a passive pressure-relieving valve, which opens when the pressure exceeds a certain maximum pressure and closes when the pressure goes below a certain minimum pressure.

The pressure-relieving valve can operate entirely passively, for example with spring elements, that is to say without switching energy being supplied, and can have hysteresis behaviour. As a result, it can be ensured completely passively that the pressure-relieving operation is ended when a desired minimum pressure is reached in the interior space of the reactor casing. In this way, the reactor casing can be protected from a possible formation of subatmospheric pressure, which can lead to it being damaged.

According to an exemplary configuration of the reactor pressure-relieving filter system, the dry filter can be a molecular sieve for the separation of iodine in gas form. Such a type of filter has proven successful in existing pressure-relieving filter systems and its filtering efficiency is for example dependent both on the average dwell time of the gas mass flow therein and the temperature difference of the gas mass flow from the respective dew point.

According to an exemplary variant, the orifice plate and the dry filter can be made to match one another, while taking into account respective gas mass flows and pressure conditions, in such a way that an approximately constant filtering efficiency is ensured; the aforementioned parameters of the average dwell time of the gas mass flow and the temperature difference of the gas mass flow from the respective dew point at least approximately compensate for one another. The dry filter is then operated in an optimum range under all pressure conditions occurring during a pressure-relieving operation.

According to a further exemplary variant, an aerosol filter is provided upstream of the orifice plate. An aerosol filter is a metal fibre filter for the separation of fission products in aerosol form and has proven successful in existing pressure-relieving filter systems.

Exemplary methods are also disclosed for dimensioning the orifice plate and the dry filter for a reactor pressure-relieving filter system according, for example, to the following steps:
dimensioning the orifice plate in such a way that a desired gas mass flow is obtained at the beginning of a pressure relief with a specified pressure in the interior space,
determining gas mass flows and achievable dew point differences for different pressure conditions in the interior space with a given orifice plate,
determining the minimum necessary dwell times in the dry filter in each case for the different pressure conditions while taking into account the respective filtering efficiency,
dimensioning the dry filter in such a way that the minimum necessary dwell time is achieved for all the different pressure conditions.

The orifice plate can be designed in such a way that, when the pressure relief is initiated in the presence of a defined pressure in the interior space of the reactor casing, the desired pressure-relieving mass flow occurs. For this purpose, first the gas mass flows and achievable dew point differences are determined in dependence on the pressure in the interior space of the reactor casing. With knowledge of the filtering efficiency curve of a zeolite, for example, the desired or specified dwell time of the gas mass flow for the entire process of the pressure relief can be determined from these two parameters. Subsequently, the depth and face area, for example, of the filter bed of the molecular sieve can be dimensioned in such a way that the desired dwell time is achieved during the entire pressure-relieving operation. Advantages which can be thereby achieved have already been explained in the description of exemplary reactor pressure-relieving filter systems.

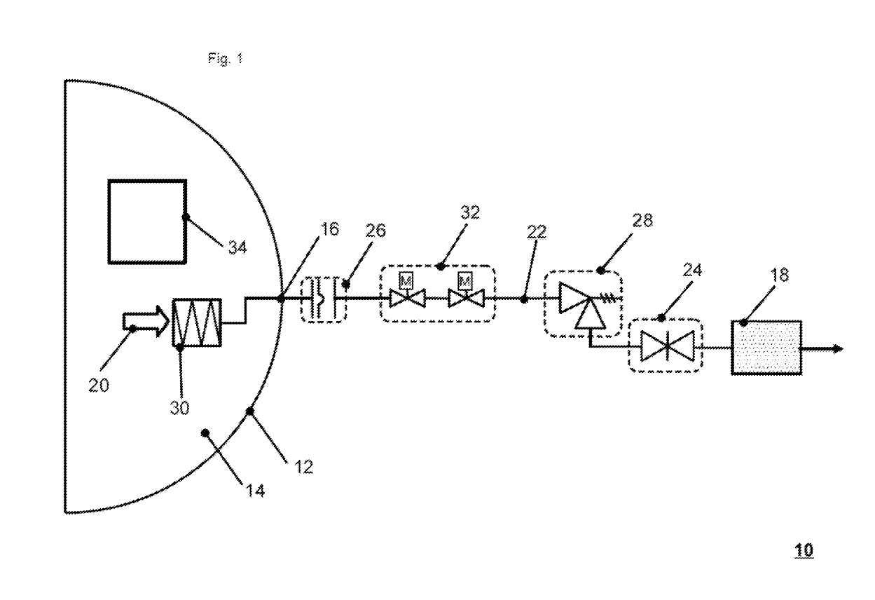

FIG. 1 shows an exemplary reactor pressure-relieving filter system 10 in a schematic representation. An interior space 14 is hermetically enclosed by a reactor casing 12. Arranged in the interior space 14 is a reactor 34, which in the event of an accident can produce an excess pressure, for example by vaporizing water into water vapour. It is known from analyses and tests that during a serious accident there can prevail in a reactor at least a temperature equivalent to the saturation temperature of the water vapour partial pressure.

The pressure-relieving operation is in this example initiated by the rupturing of a rupture disc 26, which initially hermetically seals a flow channel 22 with respect to the interior space 14. The rupture disc 26 can be a completely passive element, which ruptures when there is a specified rupturing pressure, and consequently releases the flow channel 22. Consequently, with the flow channel 22 then released, a gas mass flow 20 can be initiated on account of different pressure conditions in the interior space 14 and the surrounding environment. In a pressure relief, the gas mass flow 20 can then enter a discharge channel through an aerosol filter 30 and is conducted into the flow channel 22 through a pressure-relieving opening 16 of the reactor casing 12 to the outside.

In this example, the gas mass flow 20 initially passes motorized or manually operated penetration isolation valves 32, which however can be open as standard and are not essential to the embodiments disclosed. Following that, for example after several tens of metres of flow channel length, the gas mass flow 20 can be conducted into a passive pressure-relieving valve 28, which opens when the pressure exceeds a certain (e.g., specified) maximum pressure and closes when the pressure goes below a certain (e.g., specified) minimum pressure. The rupturing pressure of the rupture disc 26 should in any event be designed to be higher than the maximum pressure of the pressure-relieving valve 28, so that in exemplary embodiments the pressure-relieving valve 28 opens immediately in the case of pressure equalization when the rupture disc 26 ruptures.

After that, the gas mass flow 20 passes an orifice plate 24, which constricts the flow cross section of the flow channel 22. An orifice plate may for example be realized by an infinitely adjustable valve means or else also by a ring-like constricting element or the like. Almost the same pressure can prevail on the side of the orifice plate towards the interior space as in the interior space 14, a pressure reduction of the gas mass flow 20 taking place in the orifice plate 24, with simultaneous drying of the vapour, (e.g., an increase in the temperature difference between the dew point temperature and the gas mass flow temperature). Directly after flowing through the orifice plate 24, the then heated gas mass flow 20 can be conducted into a dry filter 18, in this case a molecular sieve for the filtering of iodine. The direct proximity, of for example a few metres, can for example advantageously avoid significant cooling down of the gas mass flow, so that a great temperature difference from the dew point is obtained. The filtering efficiency can be thereby increased in an advantageous way. After that, the filtered gas mass flow leaves into the surrounding environment. The pressure in the interior space can be thereby successively reduced.

The pressure-relieving valve 28 can have a hysteresis behaviour, and can end the pressure-equalizing operation when the pressure goes below a specifiable minimum pressure. If there is a renewed pressure increase above the maximum pressure, if need be a new pressure-equalizing operation can be initiated by renewed opening of the pressure-relieving valve 28.

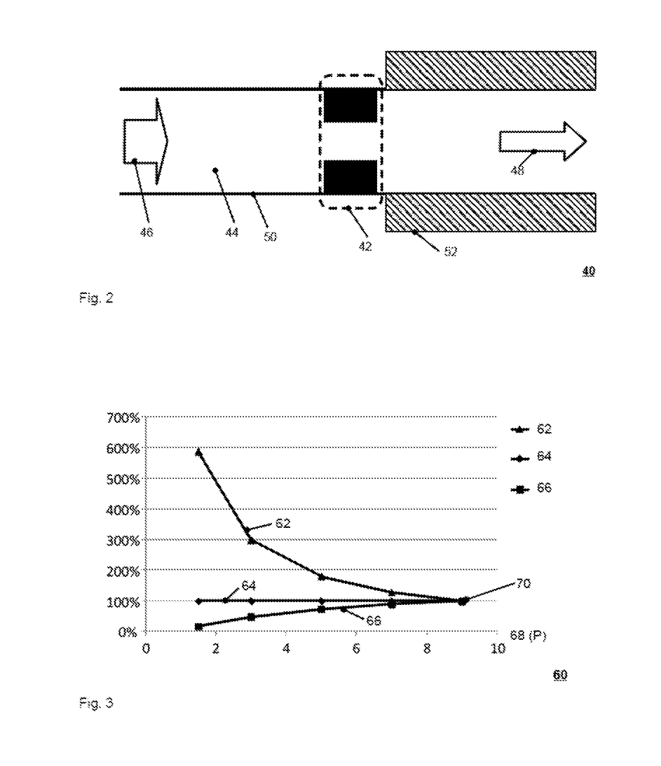

FIG. 2 shows an exemplary flow channel with an orifice plate in the view of a portion 40. The flow channel 44 is enclosed by a wall 50. Arranged in the middle of the representation is an orifice plate 42, by which the flow cross section of the flow channel 44 is reduced. A gas mass flow 46 entering from the reactor side has a relatively high pressure, is reduced in pressure as it passes the orifice plate and thereby heated, emerges again on the other side as gas mass flow 48 and is fed to a dry filter that is not shown. In order to avoid a loss in temperature of the heated gas mass flow on the way to the dry filter, in this example a thermal insulation 52 of the flow channel 44 can be provided.

FIG. 3 shows an exemplary schematic profile of the dwell time 62, the dew point difference 66 and the filtering efficiency 64 during a pressure-relieving operation according to an exemplary embodiment, with different pressure conditions 68 in a dimensionless representation 60. The pressure-relieving operation begins at a maximum pressure, as indicated by the reference numeral 70. The orifice plate can be designed in such a way that, at this maximum pressure, a desired gas mass flow is obtained. With the system pressure then falling, there can be increasingly less heating of the gas mass flow, so that the dew point difference 66 falls. On the other hand, however, the dwell time 62 in the dry filter can increase, so that these two effects compensate for one another and for example ideally a constantly high filtering efficiency 64 is obtained.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

10 exemplary reactor pressure-relieving filter system
12 reactor casing
14 interior space
16 pressure-relieving opening through reactor casing
18 dry filter
20 gas mass flow
22 flow channel
24 passive orifice plate
26 rupture disc
28 passive pressure-relieving valve
30 aerosol filter
32 penetration isolation valves
34 reactor
40 exemplary flow channel with orifice plate
42 exemplary orifice plate
44 flow channel
46 gas mass flow before passing the orifice plate
48 gas mass flow after passing the orifice plate
50 wall of the flow channel
52 thermal insulation of the flow channel
60 schematic profile of the dwell time, dew point difference and filtering efficiency during the pressure-relieving operation
62 dwell time
64 filtering efficiency
66 dew point difference
68 different pressure conditions in the dry filter
70 starting point of the pressure relief

What is claimed:

1. A reactor pressure-relieving filter system, comprising:
an interior space hermetically enclosed by a pressure-resistant reactor casing;
at least one pressure-relieving opening through the reactor casing;
a dry filter for a gas mass flow emerging from the pressure-relieving opening when there is excess pressure in the interior space, a filtering efficiency depending both on an average dwell time of the gas mass flow in the dry filter and on a temperature difference between the gas mass flow and a respective dew point;
a flow channel for connecting the pressure-relieving opening and the dry filter; and
a passive orifice plate is provided upstream of the dry filter in the flow channel.

2. The reactor pressure-relieving filter system according to claim 1, wherein the passive orifice plate is provided directly upstream of the dry filter.

3. The reactor pressure-relieving filter system according to claim 1, comprising:
in an entry region of the flow channel, a rupture disc which hermetically seals the flow channel and is configured to rupture when a specified rupturing pressure is exceeded.

4. The reactor pressure-relieving filter system according to claim 1, wherein a region of the flow channel between the passive orifice plate and the dry filter is thermally insulated, at least in certain portions, at its wall.

5. The reactor pressure-relieving filter system according to claim 1, comprising:
upstream of the orifice plate in the flow channel, a passive pressure-relieving valve which opens when a pressure exceeds a specified maximum pressure and closes when the pressure goes below a specified minimum pressure.

6. The reactor pressure-relieving filter system according to claim 1, wherein the dry filter is a molecular sieve for separation of iodine in gas form.

7. The reactor pressure-relieving filter system according to claim 1, wherein the orifice plate and the dry filter are made to match one another, while taking into account respective gas mass flows, for providing an approximately constant filtering efficiency.

8. The reactor pressure-relieving filter system according to claim 1, comprising:
an aerosol filter upstream of the orifice plate.

9. A method for dimensioning an orifice plate and a dry filter for a reactor pressure-relieving filter system according to claim 1, the method comprising:
dimensioning the orifice plate such that a desired gas mass flow is obtained at a beginning of a pressure relief with a specified pressure in the interior space;
determining gas mass flows and achievable dew point differences for different pressure conditions in the interior space with a given orifice plate;
determining a minimum necessary dwell time in the dry filter in each case for the different pressure conditions while taking into account respective filtering efficiency; and
dimensioning the dry filter to achieve the minimum necessary dwell time for the different pressure conditions.

10. The reactor pressure-relieving filter system according to claim 2, comprising:
in an entry region of the flow channel, a rupture disc which hermetically seals the flow channel and is configured to rupture when a specified rupturing pressure is exceeded.

11. The reactor pressure-relieving filter system according to claim 10, wherein a region of the flow channel between the passive orifice plate and the dry filter is thermally insulated, at least in certain portions, at its wall.

12. The reactor pressure-relieving filter system according to claim 11, comprising:
upstream of the orifice plate in the flow channel, a passive pressure-relieving valve which opens when a pressure exceeds a specified maximum pressure and closes when the pressure goes below a specified minimum pressure.

13. The reactor pressure-relieving filter system according to claim 12, wherein the dry filter is a molecular sieve for separation of iodine in gas form.

14. The reactor pressure-relieving filter system according to claim 13, wherein the orifice plate and the dry filter are made to match one another, while taking into account respective gas mass flows, for providing an approximately constant filtering efficiency.

15. The reactor pressure-relieving filter system according to claim 14, comprising:
an aerosol filter upstream of the orifice plate.

16. A method for dimensioning an orifice plate and a dry filter for a reactor pressure-relieving filter system according to claim 15, the method comprising:
dimensioning the orifice plate such that a desired gas mass flow is obtained at a beginning of a pressure relief with a specified pressure in the interior space;
determining gas mass flows and achievable dew point differences for different pressure conditions in the interior space with a given orifice plate;
determining a minimum necessary dwell time in the dry filter in each case for the different pressure conditions while taking into account respective filtering efficiency; and
dimensioning the dry filter to achieve the minimum necessary dwell time for the different pressure conditions.
